(19) United States
(12) Patent Application Publication
(10) Pub. No.: US 2024/0109582 A1
(43) Pub. Date: Apr. 4, 2024

(54) ACTIVE/SEMI-ACTIVE STEER-BY-WIRE SYSTEM AND METHOD

(71) Applicant: Lord Corporation, Cary (NC)

(72) Inventors: Anirban Chaudhuri, Cary, NC (US); Michael Jarzomski, Apex, NC (US); Askari Badre-Alam, Cary, NC (US); Russell E. Altieri, Holly Springs, NC (US)

(73) Assignee: Lord Corporation, Cary, NC (US)

(21) Appl. No.: 18/275,646

(22) PCT Filed: Feb. 4, 2022
(86) PCT No.: PCT/US2022/015247

§ 371 Date: Aug. 3, 2023

Related U.S. Application Data
(60) Provisional application No. 61/146,277, filed on Jan. 21, 2009.

(51) Int. Cl. B62D 5/00; B62D 5/04; B62D 6/00

(52) U.S. Cl. CPC B62D 5/006; B62D 5/0406; B62D 5/0475; B62D 6/008

(57) ABSTRACT

A combined brake and motor providing tactile feedback control to a human-machine interface steering input device as part of a steer-by-wire system is provided. The brake is a tactile feedback device (TFD) brake and the motor is an electric motor coupled to the brake. The brake provides end stop control and resistive torque to the steer-by-wire system. The motor provides motion control to the steer-by-wire system, where motion control includes a return-to-center, a command following, an on-center control, an active force-feel, and/or a warning mode (e.g., similar to an aircraft stick shaker or a lane departure). The steer-by-wire system is an active system.

### CROSS-REFERENCE TO RELATED APPLICATION

The present application claims priority to U.S. Provisional Application No. 63/146,277, filed on Feb. 5, 2021, which is incorporated herein by reference.

### FIELD OF INVENTION/BACKGROUND

The subject matter herein generally relates to the field of resistive torque-generating devices and motor control. More particularly, the subject matter herein relates to tactile feedback device (TFD) brakes used in conjunction with a motor to provide active/semi-active steer-by-wire control for a human-machine interface.

### BACKGROUND

Existing tactile feedback devices (TFDs) may be used for steering position output and semi-active torque feedback for steer-by-wire applications. TFD brakes that typically include one or more sensors to measure steering position, and a coil to activate magnetically responsive (MR) medium such as magnetorheological fluid (MR fluid) or magnetically responsive powder (MR powder) to produce brake torque. TFDs that include an on-board microcontroller, position sensor(s) and amplifiers, collectively referred to as a tactile feedback control unit (TFCU), can communicate with external vehicle controllers to communicate position and control brake feel. TFD's are good at providing end stop control and variable resistive torque. However, TFDs are incapable of providing active features such as return-to-center, command following, on-center control, active force-feel, or warning mode (e.g., similar to an aircraft stick shaker). Conversely, motors used for active control are good at providing the fine motion controlled active features, but provide inadequate end stop control, braking, and resistive torque. When attempts are made to use a motor to obtain an equivalent torque found in a TFD and have that motor provide end stop control, braking, and/or resistive torque, the motor must be significantly larger in size when compared to a brake and use significantly higher current levels to achieve that torque. By only using a motor with sufficient torque to address resistive brake torque as the steer-by-wire system, the motor is very large and it is nearly impossible for a human to provide control via a steering input device to overcome the peak torque.

The solution is to provide a combination TFD brake and relatively smaller motor as a steer-by-wire system capable of generating both tactile feel and shaft motion that are controlled by the TFCU. In this solution, the TFD and the motor work together to maximize their strengths and optimize the performance for the human operator.

### SUMMARY OF THE INVENTION

A combined brake and motor providing tactile feedback control to a human-machine interface steering input device as part of a steer-by-wire system is provided with this invention. The brake is a tactile feedback device (TFD) brake, and the motor is an electric motor coupled to the brake. The brake provides end stop control and resistive torque to the steer-by-wire system. The motor provides motion control to the steer-by-wire system, where motion control includes a return-to-center, a command following, an on-center control, an active force-feel, and/or a warning mode (e.g., similar to an aircraft stick shaker or a lane departure). The steer-by-wire system is an active system.

In one aspect, a steer-by-wire system providing a steering response is provided. The system comprises a brake, a motor, a shaft, at least one position sensor, and at least one microcontroller. The motor is coupled to the brake. The shaft is coupled to the brake and the motor. The at least one position sensor is capable of providing an angular position of the shaft. The at least one microcontroller contains programming suitable for providing input to the motor and the brake to create the steering response, wherein the brake, the motor and the position sensor are in electronic communication with the microcontroller.

In another aspect, a method of providing a steering response in a vehicle is provided. The method comprising an operator driving the vehicle, the driving including the operator steering a vehicle steering system, rotating the shaft by the operator to provide at least one steering input to the vehicle steering system, translating the at least one steering input into an electronic steering command with the steer-by-wire system, communicating the steering angular position to a steering controller from the at least one microcontroller, and providing a semi-active tactile feedback to the operator, the semi-active tactile feedback creating the steering response which simulates a direct linkage steering system. The vehicle steering system has a steer-by-wire system that is capable of providing the steering response, the steer-by-wire system including a brake, a motor coupled to the brake, a shaft coupled to the brake or the motor, at least one position sensor capable of generating and providing an angular position signal of the shaft, at least one microcontroller capable of providing input to the motor and the brake to create the steering response, wherein the brake, the motor and the position sensor are in electronic communication with the at least one microcontroller.

### BRIEF DESCRIPTION OF THE DRAWINGS

FIG. 1 depicts a schematic of a steer-by-wire system according to at least one embodiment.

FIG. 2A depicts a perspective view of a configuration of a steer-by-wire system with a motor coupled in-line with a tactile feedback device (TFD) brake.

FIG. 2B depicts a perspective view of a different configuration of a steer-by-wire system with a motor coupled in-line with a TFD drum brake.

FIG. 3 is side view of a TFD brake and motor from FIG. 2A.

FIG. 4 is a side view of a TFD brake and motor from FIG. 2B.

FIG. 5 is a side view of a TFD disk brake having a motor coupled in-line therewith.

FIGS. 6A-6C depict an example of a steering input device attached to the steer-by-wire system.

FIGS. 7A and 7B depict another example of a steering input device attached to the steer-by-wire system.

FIG. 8 depicts the electronic communications for the steer-by-wire system.

FIG. 9 depicts a method of creating an artificial feel using a steer-by-wire system.

FIG. 10 depicts the process flow diagram for the Feel Algorithm.

FIG. 11 depicts the process flow diagram for the Motion Algorithm.

FIG. 12 depicts the process flow diagram for the Current Algorithm.

FIG. 13 is a plot of torque v. current.

### DETAILED DESCRIPTION

Current tactile feedback devices (TFDs) are predominately brakes including magnetorheological fluid (MR fluid) or magnetically responsive powder (MR powder) and are used for steering position output and semi-active torque feedback for steer-by-wire applications. These devices include one or more sensors to measure steering position, and a brake coil to activate MR fluid or MR powder to produce a braking torque. As disclosed herein, the TFD is coupled with a motor to at least overcome the “off-state” torque of the device. This minimum torque is the torque necessary to provide motion control such as return-to-center, command following, on-center control, active force-feel, or warning mode.

In the embodiments disclosed herein, a brake is combined with a motor to provide steer-by-wire control for the human-machine interface. The combination may be referred to as an active hybrid steer-by-wire system.

In many cases the human-machine interface is a steering input device such as a wheel or yoke, but it can also be a control stick or a joystick, as well as any other device that can provide control input from a human and require a tactile feedback.

The brake described below is a TFD brake, but the system can use any brake that is capable of providing end stop control, braking, and/or resistive torque. Thus, the usage of a TFD brake herein is meant only to be a representative type of brake and it is not meant to be limiting to only a TFD brake, or a MR TFD brake.

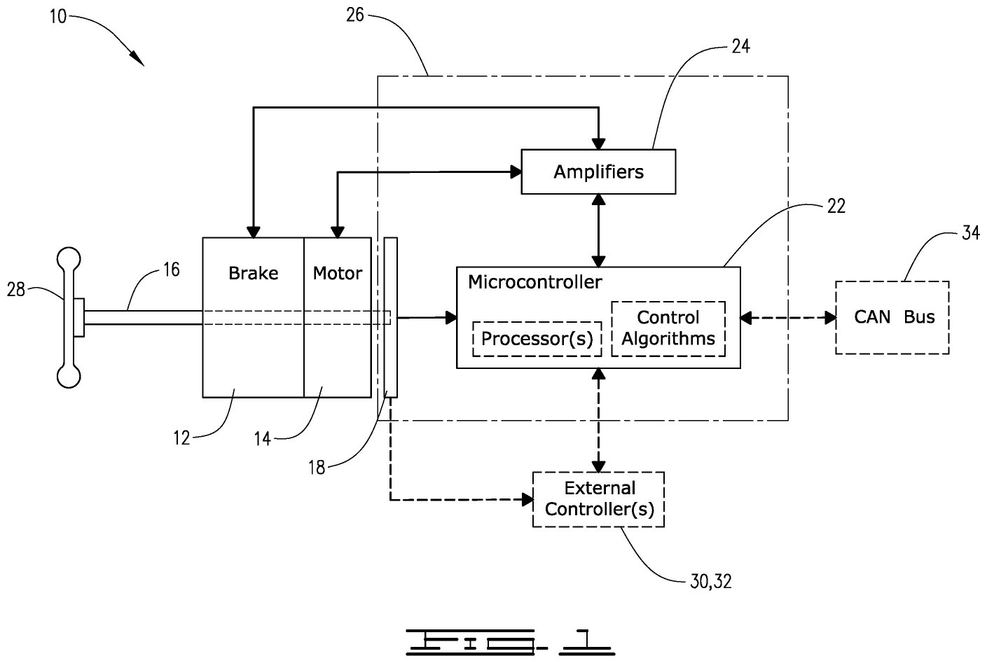

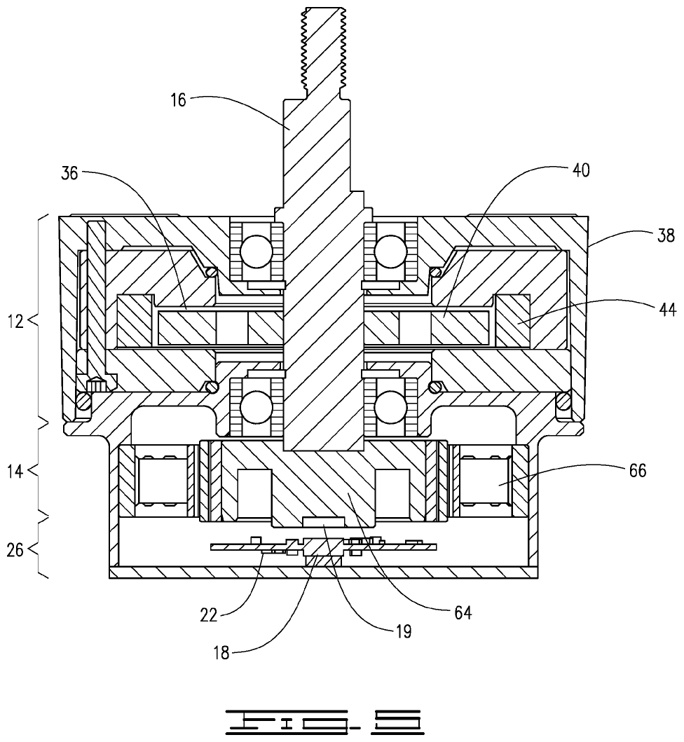

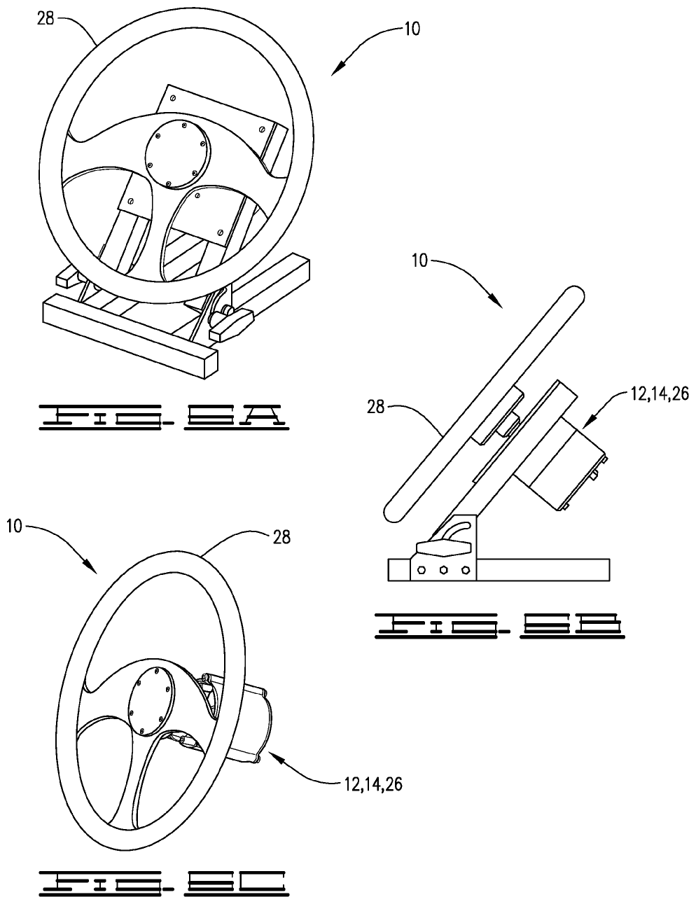

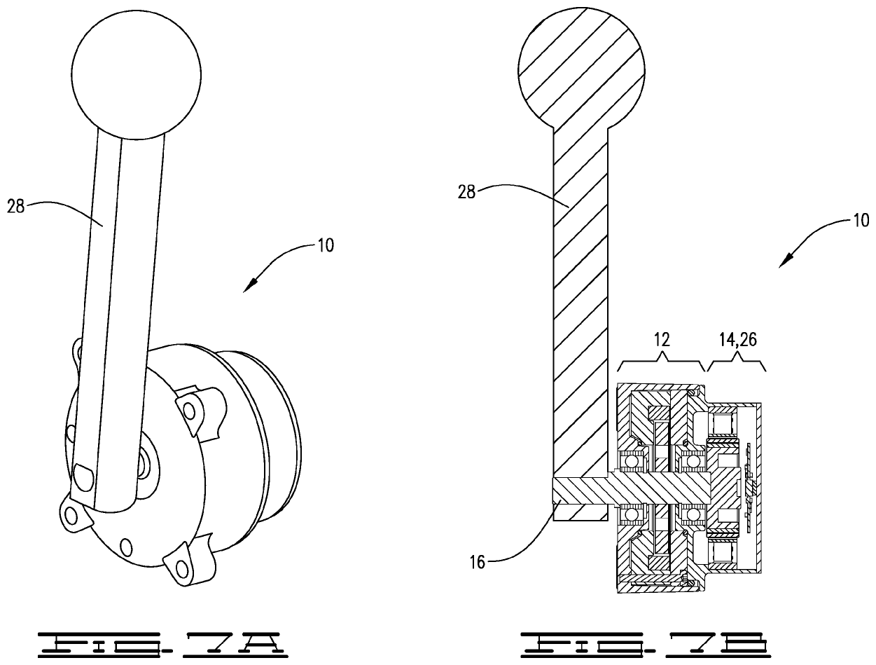

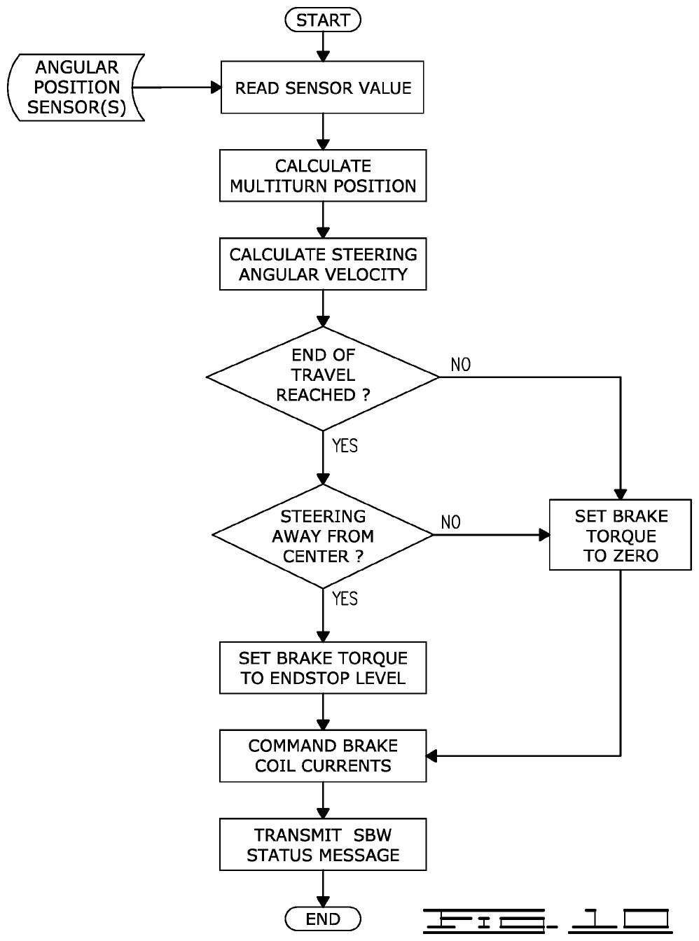

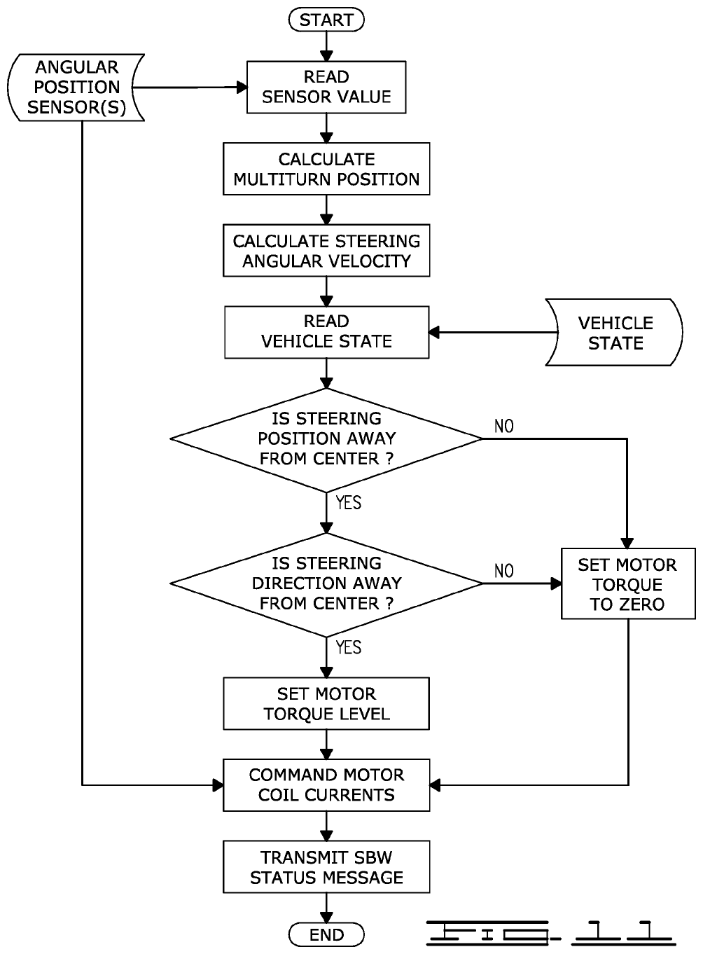

Referring to FIGS. 1-7B, the steer-by-wire system, generally referred to as device 10 or steer-by-wire system 10, identified in FIGS. 10 and 11 as SBW, includes a brake 12, a motor 14, a shaft 16, at least one position sensor 18, at least one microcontroller 22. Motor 14 is coupled to brake 12. Shaft 16 is coupled to brake 12, motor 14, or both brake 12 and motor 14. Position sensor 18 is positioned to provide an angular position of shaft 16. Microcontroller 22 is in electronic communication with brake 12, motor 14, and sensor 18 and contains programming suitable for carrying out the computations and commands necessary to provide the desired tactile feedback to an operator. Microcontroller 22 is capable of providing control input to brake 12 and motor 14. Microcontroller 22 is able to communicate reference inputs to motor 14 suitable for actively controlling rotation of shaft 16. Collectively, microcontroller 22, position sensor 18, and amplifiers 24 form tactile feedback control unit (TFCU) 26. TFCU 26 executes feel and motion control algorithms for tactile feel and provides for communication with external controllers. An example feel algorithm is provided in FIG. 10 and an example motion algorithm is provided in FIG. 11.

Shaft 16 is directly or indirectly coupled to steering input device 28. Microcontroller 22 is in electronic communication with steering controller 30, vehicle controller 32, and/or CAN bus 34 (Controller Area Network bus). Alternatively, microcontroller 22 is in electronic communication with steering controller 30 and/or vehicle controller 32 via CAN bus 34. Microcontroller 22 is able to receive electronic communications from steering controller 30 and/or vehicle controller 32 directly or via CAN bus 34. Steering controller 30 and/or vehicle controller 32 are collectively referred to as external controllers.

Any motor 14 can be used in this application, but a frameless brushless direct current motor (BLDC) is referred to herein as an acceptable solution. However, the use of a BLDC motor is not meant to limit the invention to only a BLDC motor. The frameless design of the BLDC motor 14 allows for easier mechanical integration in-line with brake 12, while the brushless design ensures long life and low maintenance. When combined with brake 12, motor 14 is positioned to actively control shaft 16.

Motor control is performed using output(s) from position sensor 18 along with appropriate commutation electronics. Motor 14 includes motor rotor 64, and stator 66 and at least one winding coil (not shown). Motor rotor 64 rotates with shaft 16 which either passes through motor rotor 64 or is mated to motor rotor 64. At least one optional amplifier 24 capable of transmitting a variable current through the at least one winding coil may be used. The same or a different optional amplifier 24 may be used to transmit and receive signals with brake 12.

In the embodiments illustrated in FIGS. 1-4, brake 12 is coupled with motor 14. The coupling is illustrated in FIGS. 1-4 as being in line with brake 12 below motor 14 and along a centerline of both brake 12 and motor 14; however, motor 14 may also be positioned in line and above brake 12. In addition, motor 14 may be externally positioned, i.e. offset, relative to brake 12. Accordingly, the illustrated embodiments are meant to be a non-limiting and only for exemplary purposes. In all embodiments, motor 14 is capable of generating sufficient torque to at least overcome an off-state torque of the steer-by-wire system. The term “off-state” refers to the minimum frictional torque in the assembly with zero excitation current in the brake coil. It is mainly comprised of friction in the bearings, seals, and between unenergized MR material and brake surface.

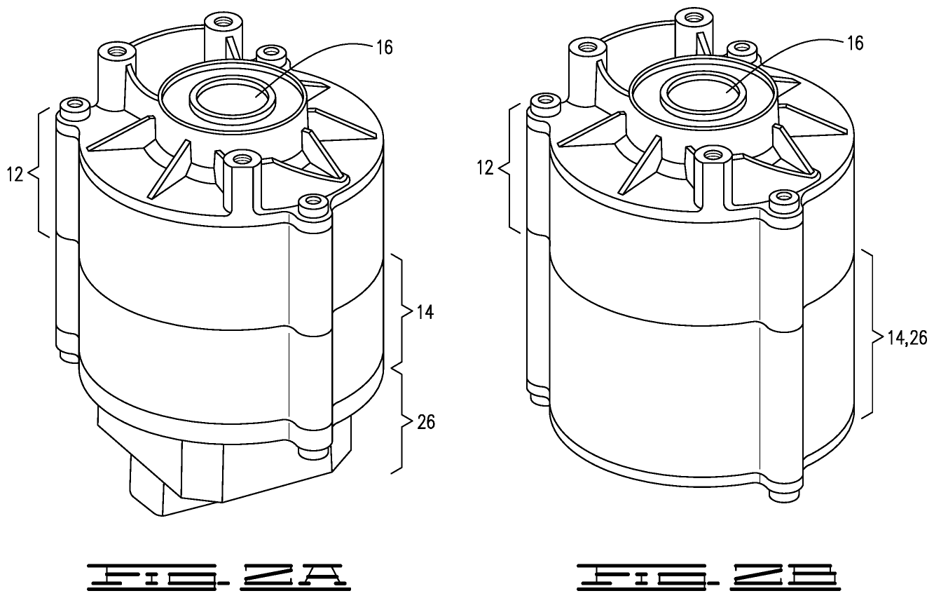

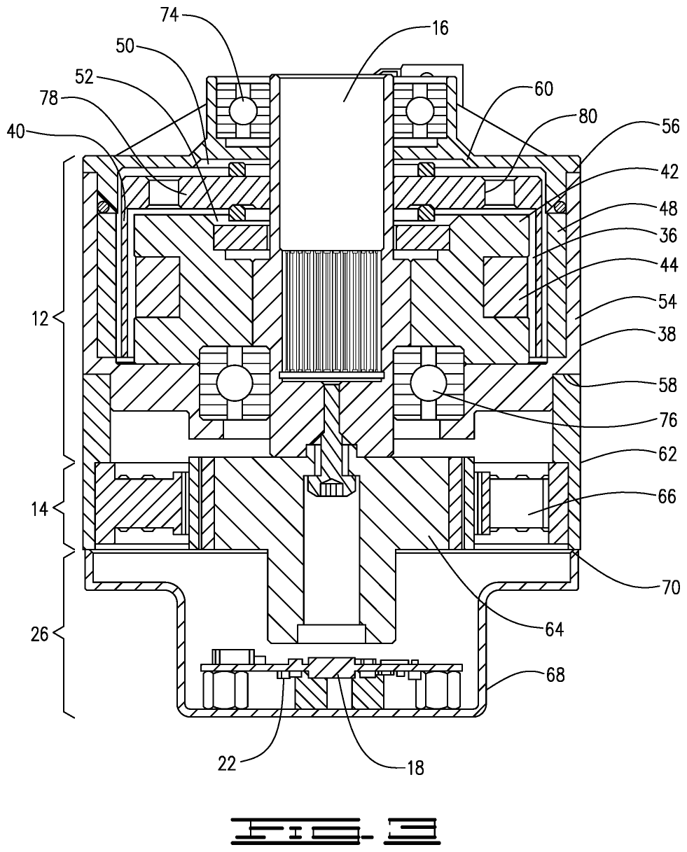

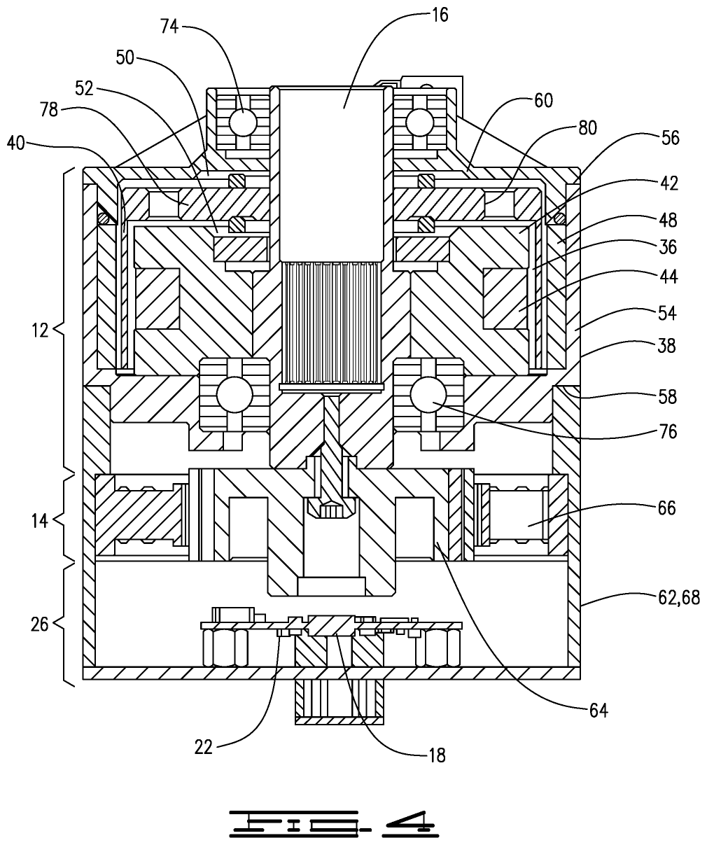

Brake 12 may be a TFD brake, a drum brake, a disk brake, a friction brake, an electromagnetic brake, or combinations thereof. For illustrations purposes only, FIGS. 2A-4 depict a TFD drum brake 12 using MR material 36. Referring to FIGS. 3 and 4, TFD drum brake 12 has housing 38 enclosing shaft 16, drum rotor 40, core 42 having a brake coil 44, pole ring 48, MR material 36, upper seal 50, and lower seal 52 within. Housing 38 includes housing wall 54. Housing wall 54 includes housing top 56 and housing bottom 58. Housing cap 60 is secured to housing top 56. Housing cap 60 is made from a non-magnetic material (e.g., 628861-T6 Aluminum or similar material).

In some embodiments, housing 38 has at least a portion of motor 14 positioned within housing 38. As illustrated in FIGS. 3 and 4, motor housing 62 is secured to housing bottom 58 and encloses motor rotor 64 and stator 66. Alternatively, motor rotor 64 and stator 66 are enclosed within housing 38. In a non-limiting configuration, a sensor housing 68 is secured to motor housing bottom 58 containing at least one microcontroller 22 for TFD drum brake 12 and motor 14.

Shaft 16 is rotatably disposed within housing 38 and motor housing 62. In some embodiments, shaft adapter 72 supports shaft 16 with motor rotor 64 and stator 66 positioned outwardly therefrom. As illustrated, shaft 16 is rotatably supported by upper bearings 74 and lower bearings 76, along with shaft adapter 72. In the TFD drum brake 12 configuration, shaft 16 has rotation disk 78 attached thereto and extending radially outward therefrom. Drum rotor 40 is connected to rotation disk 78 at end 80 of rotation disk 78 and rotates with shaft 16. As illustrated in FIGS. 3 and 4, drum rotor 40 extends radially outward from end 80 and is perpendicular to shaft 16 before it bends parallel to shaft 16 and perpendicular to rotation disk 78. Optionally, rotation disk 78 can extend radially outward and drum rotor 40 can be parallel to shaft 16. Additionally, drum rotor 40 and rotation disk 78 can be a single component directly affixed to shaft 16.

In this configuration, TFD drum brake 12 provides braking, end stop control, and resistive torque. Brake 12 is able to provide a peak resistive force between 5 Newton meters and 25 Newton meters; however, the commonly desired peak resistive force will vary with the application of the TFD system. Motor 14 provides motion control to include return-to-center, command following, on-center control, active force-feel, or warning mode (e.g., similar to an aircraft stick shaker or a lane departure). In one embodiment, the warning mode involves an active pulsation input to shaft 16 in order to create vibratory feedback and indicate a specific warning or abnormal vehicle condition. Motor 14 can also be used for command following applications. For example, if a vehicle is being steered autonomously using global position system guided navigation, then movements of steering input device 28 will follow the actual vehicle movements. Similarly, when used on a boat having two steering input stations, movement of the steering input station not in use is synchronized with the steering input station in use. In this way, the two steering input devices 28 have matching movements.

Motor 14 is able to provide a force between about 0.5 Newton meters and about 5 Newton meters. Also, motor 14 is able to provide a force that exceeds an off-state brake torque level between about 0.01% and about 25.0% of a maximum possible resistive brake torque for brake 12. Device 10 in this configuration limits the amount of torque generated in steering input device from motor 14, and is safe for steer-by-wire applications since it cannot overwhelm the operator. Steer-by-wire systems 10 provide an artificial steering response to the operator through steering input device 28.

Microcontroller 22 controls both TFD brake 12 and motor 14. Position sensor 18 provides communication of the angular position of shaft 16 to the microcontroller. Additional sensors (not illustrated) may also communicate brake 12, motor 14, and shaft 16 information to microcontroller 22. Microcontroller 22 may be a single microcontroller providing control over both brake 12 and motor 14. Alternatively, microcontroller 22 may be two more microcontrollers 22 with at least one dedicated to controlling brake 12 and one dedicated to controlling motor 14.

Position sensor 18 comprises one or more sensors. Position sensor 18 may be an absolute position sensor, an optical position sensor, a Hall effect sensor, an encoder, a resolver, or combinations thereof. Position sensor 18 is capable of measuring an angular position of shaft 16 and communicating those measurements to microcontroller 22. Position sensor 18 may be in direct electronic communication, indirect electronic communication, or both direct electronic communication and indirect electronic communication with an external controller such as steering controller 30 and/or vehicle controller 32. The external controller is separate from microcontroller 22 in steer-by-wire system 10. As known to those skilled in the art, each described version of sensor 18 will “read” a location point on the end of shaft 16. For example, when using a Hall effect sensor 18, a magnet 19 will be located in the end of shaft 16.

In one embodiment, position sensors 18 are non-contact sensors. The sensor measurements are used by microcontroller 22, along with along with advanced motion control algorithms, to control rotation of shaft 16, and when idle return shaft 16 back to center when the operator is not operating steering input device 28. An example of a suitable motion control algorithm is provided in FIG. 11. The sensor measurements are also able to be transmitted with one or more different communication techniques (e.g., analog, PWM, digital) to steering controller 30 and/or vehicle controller 32.

In an embodiment with two or more position sensors 18, position sensors 18 are able to provide shaft 16 angular position within a margin of error between about −5 degrees to about +5 degrees. For a more refined device 10, position sensors 18 are able to provide a shaft 16 angular position within a margin of error of about ±3 degrees, or a shaft 16 angular position within a margin of error of at least ±1 degrees. The location of each sensor 18 will be selected to provide the degree of accuracy needed for the system, e.g. one sensor 18 on top of the printed circuit board supporting the microcontroller and one sensor 18 underneath the printed circuit board. In one embodiment, the disclosed steer-by-wire system 10 does not require a gear pack or an assembly of gears between shaft 16 and the position sensor 18 to support or drive position sensor 18. As a result, in the disclosed invention, position sensors 18 may be on axis and in-line with shaft 16. Locating positions sensors 18 on the axis of shaft 16 reduces the complexity of the sensor assembly thereby reducing the number of potential failure modes and mechanical noise. Additionally, the configuration of components provides manufacturing efficiencies. However, off-axis locations of position sensors 18 will also perform satisfactorily in the steer-by-wire system 10.

In operation, motor 14 is capable of providing an input to induce an artificial steering response for the operator through steering input device 28. The inputs include a return-to-center, an alert warning, a midrange feel, active force feel, wheel traction feel, wheel slip feel, and/or two or more steering synchronizations. Two or more steering synchronizations means that there are two or more steering input devices 28 that are synchronized together to have synchronized movement and response.

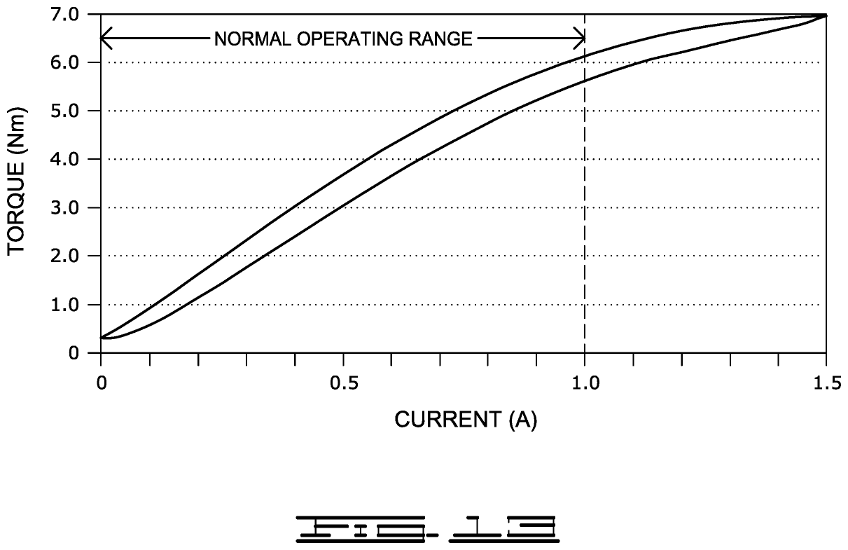

In the representative embodiments illustrated in FIGS. 3 and 4, there are four shear surfaces: two between the core 42 and the drum rotor 40 and two between the drum rotor 40 and the pole ring 48. When brake 12 is a TFD brake using MR material 36, integrated coil 44 is capable of energizing/activating MR material 36 upon the application of a magnetic field. The application of a current creates the magnetic field that in turn causes an alignment of the magnetically responsive particles found in MR material 36. This causes MR material 36 to shear on all four surfaces. The shearing creates resistive torque. Additionally, the amount of current applied controls the amount of resistive torque. When MR material 36 is activated and controlled by application of current, brake 12 produces finely controlled mid-range torque or the maximum possible torque at end of travel. FIG. 13 depicts an example of the resistive torque produce by brake 12 as current to brake coil 44 is increased from zero Amps to 1.5 Amps. As represented by the resulting curve, the produced torque continuously increases with the increased application of current to brake coil 44. The torque transition with current change translates to smooth control of the resistive torque experienced by the user of steer-by-wire system 10. The normal operating range for the torque curve will vary depending on the application of steer-by-wire system 10.

Microcontroller 22, through control of brake 12 and motor 14, provides a variable tactile feel to the human operator through steering input device 28. Microcontroller 22 controls the braking, end stop control, and resistive torque of brake 12. This is accomplished by controlling the current to integrated coil 44 and/or by providing a command input to brake 12 where the command input produces a braking action that replicates an end-of-travel stop, a normal operation, and/or a resistive force corresponding to an action associated with the steering response.

Additionally, microcontroller 22 is able to communicate commands to motor 14 to provide the motion control. For example, in one embodiment microcontroller 22 provides return-to-center operation capabilities. In this embodiment, microcontroller 22 using position sensor 18 detects movement of steering shaft 16 away from the center position and provides a command to motor 14 to return shaft 16 to a center position. Also, microcontroller 22 is able to communicate commands to motor 14 suitable for controlling the angular position of shaft 16, introducing a warning command/mode to shaft 16 causing shaft 16 to vibrate or dither, providing on-center control, and/or providing an active force-feel input to shaft 16.

Microcontroller 22 is able to estimate torque experienced by shaft 16 from the current being used by device 10. Additionally, to provide the previously discussed control operations, microcontroller 22 is able to receive and process measurements of the angular position of shaft 16 from one or more position sensors 18. Preferably, each position sensor 18 is located in alignment with the axis of shaft 16.

In operation, microcontroller 22 is able to command motor 14 with one or more currents having a specific phase difference for commutation and is able to turn motor 14 in a desired direction in order to provide the motion control input to shaft 16.

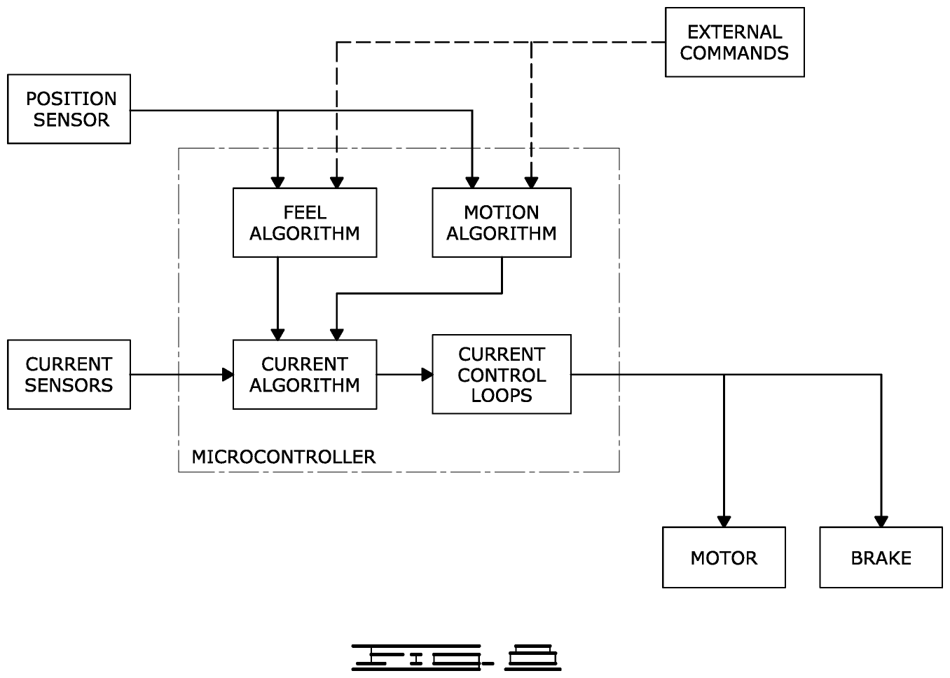

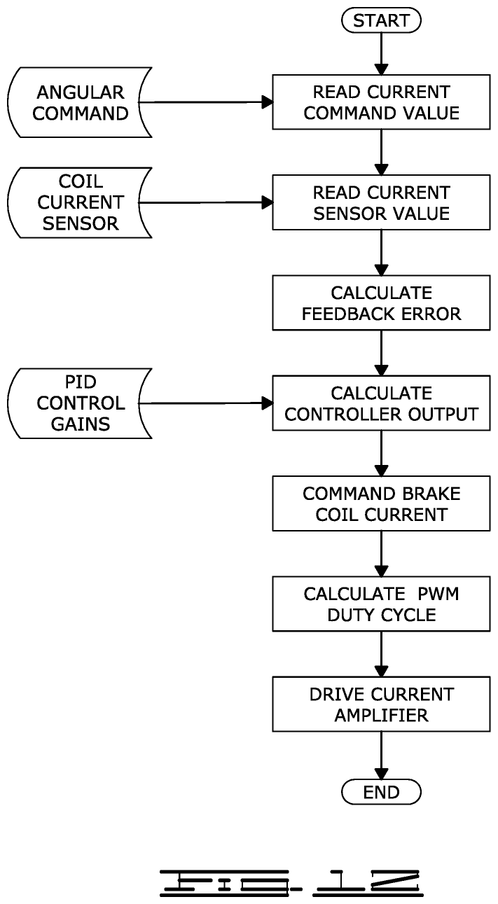

Referring to FIG. 8, the electronic communication between the various elements of the steer-by-wire system is illustrated. Position sensor 18 communicates with microcontroller 22. Within microcontroller, position sensor 18 provides data to feel algorithms and motion algorithms. Similarly, external commands from external controllers such as steering controller 30 or vehicle controller 32 communicate data to the feel algorithms and motion algorithms. The feel algorithms and motion algorithms provide data to current algorithms. Examples of a suitable feel algorithm is provided in FIG. 10 and a suitable motion algorithm is provided in FIG. 11. At least one current sensor associated with motor 14 and brake coil 44 also provides data to current algorithms. The current algorithms provide data to the current control loops which in turn communicate to both motor 14 and brake 12. An example of a suitable current algorithm is provided in FIG. 12.

Device 10 is capable of being installed on a vehicle (not shown) where an active steer-by-wire system is desired. Type of vehicles may be construction vehicles, agriculture vehicles, forestry vehicles, transportation vehicles, material handling vehicles, marine craft, and aircraft.

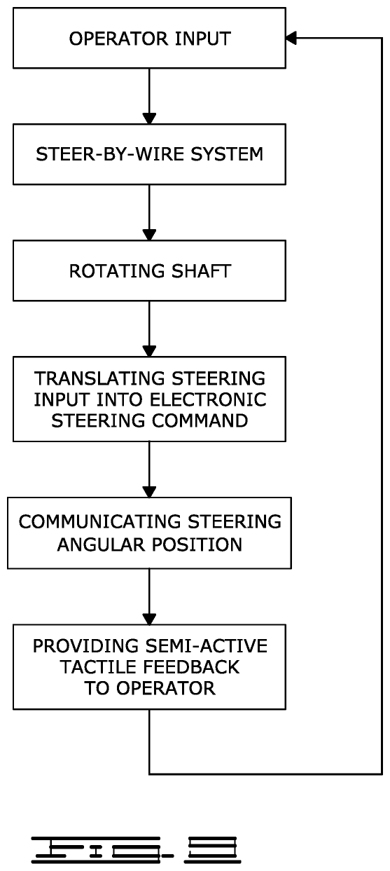

Referring to FIG. 9, the use of device 10 in an active system allows for a method of providing a steering response in a vehicle. The method includes steering a vehicle steering system by an operator. In this case the vehicle steering system employs device 10 as an active steer-by-wire system. With device 10 installed, the active steer-by-wire controlling mechanism provides an artificial steering response. Device 10 is described above and includes brake 12, motor 14 coupled to brake 12, shaft 16 coupled to brake 12 or motor 14, at least one position sensor 18 that is capable of generating and providing an angular position signal of shaft 16, at least one microcontroller 22 capable of providing input to motor 14 and brake 12 so as to create the artificial steering response. Brake 12, motor 14, and position sensor 18 are in electronic communication with microcontroller 22.

The method further includes having an operator drive the vehicle and rotate shaft 16 by providing at least one steering input to the vehicle steering system. The method also includes position sensor 18 translating the steering input into an electronic steering command. The steering angular position determined by position sensor 18 is communicated to a steering controller 30 by microcontroller 22. Device 10 provides a semi-active tactile feedback to the operator. The semi-active tactile feedback creates the artificial steering response which simulates a direct linkage steering system.

In the method, the steering response includes the ability to provide a plurality of electronic steering commands including: an end stop control, a resistive torque, a return-to-center, at least one deviation warning, traction feel, wheel slip feel, on center feel, and/or a steering synchronization.

The semi-active tactile feedback is based on combination of position sensor 18, a calculated steering velocity, i.e. angular velocity, a calculated steering acceleration, i.e. angular acceleration, or a digital input from the steering controller 30. The semi-active tactile feedback includes a constant, periodic or a variable braking torque generated by sending a current through integrated coil 44. As discussed application of the current and control of the current is provided by microcontroller 22.

In the method, the step of rotating shaft 16 further comprises measuring the operator's steering input via shaft 16 by position sensor 18. Position sensor 18 communicates a position signal to microcontroller 22 and/or steering controller 30. Microcontroller 22 or TFCU 24 using microcontroller 22 provides semi-active tactile feedback to the operator through control and adjustment of brake 12 and/or the motor 14.

As described above, the method provides for returning shaft 18 to a center position when position sensor 18 fails to detect the operator providing at least one steering input after a manufacturer selected interval.

The method allows for controlling brake 12 with a first of at least two microcontrollers 22 and controlling motor 14 with a second of at least two microcontrollers 22. Regardless of whether there is one microcontroller 22 or more than one microcontroller 22, the method provides for the microcontroller controlling motor 14 to use an angular position signal from position sensor 18 and be able to calculate the required commutation signals for a brushless direct current (BLDC) motor 14.

Other embodiments of the present invention will be apparent to one skilled in the art. As such, the foregoing description merely enables and describes the general uses and methods of the present invention. Accordingly, the following claims define the true scope of the present invention.

1. A steer-by-wire system providing a steering response, the system comprising:
a brake located within a brake housing;
a motor coupled in-line with the brake, the motor located within a motor housing and the motor housing secured to the brake housing;
a shaft coupled to the brake and/or the motor;
at least one position sensor capable of providing an angular position of the shaft;
at least one microcontroller capable of providing input to at least one of the motor and the brake to create the steering response, wherein the brake, the motor and the position sensor are in electronic communication with the microcontroller.

2. The steer-by-wire system of claim 1, further comprising at least two microcontrollers, wherein one of the at least two microcontrollers provide control to the brake and one of the at least two microcontrollers provides control to the motor.

3. The steer-by-wire system of claim 1, wherein the brake is a TFD brake, a drum brake, a disk brake, a friction brake, or an electromagnetic brake.

4. The steer-by-wire system of claim 1, wherein the brake is a TFD brake which includes magnetorheological fluid (MR fluid) or magnetically responsive powder (MR powder, the TFD brake provides a variable resistive torque and is capable of providing an end stop torque.

5. (canceled)

6. The steer-by-wire system of claim 1, wherein at least a portion of the motor is positioned within the brake housing.

7. The steer-by-wire system of claim 1, wherein the brake is a TFD brake comprising:
a rotation disk rotatably connected to the shaft;
a drum rotor connected to the rotation disk;
a core having an integrated coil positioned radially inward from the drum rotor forming a first gap therebetween;
a pole ring fixedly positioned radially outward from the drum rotor forming a second gap therebetween;
a magnetically responsive (MR) material disposed within the first gap and the second gap;
an upper seal positioned to block MR material moving from the second gap;
a lower seal positioned to block MR material moving from the first gap; and
a housing enclosing the shaft, the drum rotor, the core, the upper seal, and the lower seal, the housing having a housing cap and a sensor housing secured thereto.

8. The steer-by-wire system of claim 1, wherein brake is a TFD disk brake comprising:
a rotor mounted to the shaft and manufactured from magnetically permeable material, the rotor being shaped to have a working portion on its periphery which extends parallel to the shaft on which the rotor is mounted;
the housing having a first sealed chamber rotatably housing the rotor therein, and including a magnetic field generator spaced from the rotor, and positioned for generating a magnetic flux in a direction perpendicular to the shaft and to the working portion of the rotor, and the housing including a second sealed chamber, the second sealed chamber housing a brake control electronics system for controlling and monitoring an operation of the brake; and
a controllable magnetically responsive (MR) material disposed within the first sealed chamber, the MR material in contact with at least the working portion of the rotor, the MR material being responsive to a magnetic field generated by the magnetic field generator.

9. (canceled)

10. The steer-by-wire system of claim 1, further comprising two or more position sensors.

11. (canceled)

12. (canceled)

13. The steer-by-wire system of claim 10, wherein the two or more sensors are able to provide a shaft position within a margin of error between about −5 degrees to about +5 degrees.

14. (canceled)

15. (canceled)

16. The steer-by-wire system of claim 10, wherein the signal from the position sensor includes a measurement of an angular position of the shaft.

17. (canceled)

18. The steer-by-wire system of claim 1, further comprising at least one amplifier capable of transmitting a variable current through at least one winding coil of the motor.

19. (canceled)

20. (canceled)

21. (canceled)

22. (canceled)

23. (canceled)

24. (canceled)

25. (canceled)

26. The steer-by-wire system of claim 1, wherein the microcontroller is capable of providing a variable tactile feel.

27. The steer-by-wire system of claim 26, wherein the microcontroller is capable of communicating a command to the motor to return-to-center in the absence of an input from the position sensor.

28. The steer-by-wire system of claim 26, wherein the microcontroller is capable of communicating a command to the motor to return-to-center in the absence of a motion, wherein the motion is detected by a contactless position sensor.

29. The steer-by-wire system of claim 26, wherein the microcontroller is capable of communicating a command to the motor to control the angular position of the shaft.

30. The steer-by-wire system of claim 26, wherein the microcontroller is capable of communicating a command to the motor to introduce a warning command to the shaft causing the shaft to vibrate or dither.

31. The steer-by-wire system of claim 26, wherein the microcontroller includes programming suitable for providing a command input to the brake, the command input producing a braking action that replicates an end of travel stop, a normal operation, and/or a resistive force corresponding to an action associated with the steering response.

32. (canceled)

33. The steer-by-wire system of claim 1, wherein the steer-by-wire system does not include a gear pack between the at least one position sensor and the shaft coupled to the brake and/or motor.

34. (canceled)

35. The steer-by-wire system of claim 1, wherein the microcontroller is able to measure and process angular position measurements communicated from the position sensor.

36. The steer-by-wire system of claim 1, wherein the microcontroller is able to command the motor with a current having a specific phase difference for commutation and is able to turn the motor in a desired direction.

37. (canceled)

38. The steer-by-wire system of claim 1, wherein the motor is capable of providing a force that exceeds an off-state brake torque level between about 0.01% and about 25.0% of a maximum possible resistive brake torque for the brake.

39. (canceled)

40. (canceled)

41. (canceled)

42. (canceled)

43. A method of providing a steering response in a vehicle, the method comprising:
an operator driving the vehicle;
the driving including the operator steering a vehicle steering system, the vehicle steering system having a steer-by-wire system that is capable of providing the steering response, the steer-by-wire system including;
a brake located within a brake housing;
a motor coupled in-line with the brake, the motor located within a motor housing and the motor housing secured to the brake housing;
a shaft coupled to the brake or the motor;
at least one position sensor capable of generating and providing an angular position signal of the shaft;
at least one microcontroller capable of providing input to the motor and the brake to create the steering response, wherein the brake, the motor and the position sensor are in electronic communication with the at least one microcontroller;
rotating the shaft by the operator providing at least one steering input to the vehicle steering system;
translating the at least one steering input into an electronic steering command with the steer-by-wire system;
communicating an angular position of the shaft to a steering controller from the at least one microcontroller;
providing a semi-active tactile feedback to the operator, the semi-active tactile feedback creating the steering response which simulates a direct linkage steering system.

44. The method of claim 43, wherein the steering response include is capable of providing a plurality of electronic steering commands selected from the group consisting of: an end stop control, a resistive torque, a return-to-center, at least one deviation warning, traction feel, wheel slip feel, on center feel, and a steering synchronization.

45. The method of claim 43, wherein the semi-active tactile feedback is based on combination of a steering sensor position, a steering velocity, a steering acceleration, or a digital input from the steering controller.

46. The method of claim 45, wherein the semi-active tactile feedback includes a constant, periodic or a variable braking torque generated by sending a current through an integrated coil.

47. The method of claim 43, wherein the step of rotating the shaft further comprises measuring the operator's at least one steering input via the shaft by the position sensor, the position sensor communicating a position signal to the at least one microcontroller or the steering controller, the at least one microcontroller providing the semi-active tactile feedback to the operator through the brake and/or the motor.

48. The method of claim 43, further comprising returning the shaft to a center position when the at least one position sensor detects no change in at least one steering input from the operator during a manufacturer selected interval.

49. The method of claim 43, further comprising controlling the brake with a first of at least two microcontrollers and controlling the motor with a second of the at least two microcontrollers.

50. The method of claim 44, further comprising the step of using the angular position signal from the at least one position sensor in the at least one microcontroller to calculate the required commutation signals for a brushless direct current (BLDC) motor.
